(19) United States
(12) Patent Application Publication
(10) Pub. No.: US 2021/0011215 A1
(43) Pub. Date: Jan. 14, 2021

(54) Active optical fiber HDMI connecting device

(71) Applicant: Jianfeng DING, Anhui (CN)

(72) Inventor: Jianfeng DING, Anhui (CN)

(21) Appl. No.: 16/505,726

(22) Filed: Jul. 9, 2019

(51) Int. Cl. G02B 6/02; H04N 7/00; G09G 5/00; H04N 21/4363

(52) U.S. Cl. CPC G02B 6/02042; H04N 7/005; G09G 2370/18; H04N 21/43635; G09G 5/006

(57) ABSTRACT

An active optical fiber HDMI connecting device, having a transmitting terminal, a receiving terminal, optical fibers, and a power source module; the power source module provides power to the transmitting terminal and the receiving terminal; the transmitting terminal includes a signal input module and an electro/optical (E/O) conversion module; the receiving module comprises an optical/electro (O/E) conversion module and a signal receiving module; the signal input module inputs digital electro signals to the E/O conversion module; the E/O conversion module converts the digital electro signals to optical signals; the optical fibers transmit the optical signals to the O/E conversion module; the O/E conversion module converts the optical signals to digital electro signals; the signal receiving module receives the digital electro signals converted by the O/E conversion module.

### BACKGROUND OF THE INVENTION

The present invention relates to a kind of active optical fiber HDMI connecting device.

HDMI (High Definition Multimedia Interface) is a kind of interface technology for digital video/audio. An HDMI connecting wire can transfer non-compressed data of high definition video and multichannel audio in high quality, and the highest speed of data transfer is 18 Gbps. Also, it is not required to perform digital/analog or analog/digital conversion between signal transfer, thereby ensuring the transfer of the finest quality of video and audio signals. However, an HDMI connecting device in the prior art has complicated structure and a high production cost.

### BRIEF SUMMARY OF THE INVENTION

In view of the aforesaid disadvantages now present in the prior art, the present invention provides the following technical solutions:

An active optical fiber HDMI connecting device, comprising a transmitting terminal, a receiving terminal, optical fibers, and a power source module; the power source module provides power to the transmitting terminal and the receiving terminal; the transmitting terminal comprises a signal input module and an electro/optical (E/O) conversion module; the receiving module comprises an optical/electro (O/E) conversion module and a signal receiving module; the signal input module inputs digital electro signals to the E/O conversion module; the E/O conversion module converts the digital electro signals to optical signals; the optical fibers transfer the optical signals to the O/E conversion module; the O/E conversion module converts the optical signals to digital electro signals; the signal receiving module receives the digital electro signals converted by the O/E conversion module.

The signal input module is a first single chip of model number Y51S019P; the E/O conversion module is a VCSEL driver chip; the signal receiving module is a second single chip of model number Y51S019P; the O/E conversion module is a PIN_PD driver chip; the first single chip, the VCSEL driver chip and the PIN_PD driver chip are electrically connected; the second single chip is electrically connected to the PIN_PD driver chip.

Bias voltage and an impedance matching module are provided between the first single chip and the VCSEL driver chip.

A resonance frequency matching module is connected between the second single chip and the PIN_PD driver chip.

The signal input module and the signal receiving module are electrically connected with each other; the signal input module is also connected in sequence with a first control switch and a first LED module; the signal input module inputs a power source signal to the signal receiving module; after the signal receiving module has received the power source signal, the signal receiving module transmits a high level signal to the signal input module; after the signal input module has received the high level signal, the signal input module transmits a control signal to the first control switch; the first control switch receives the control signal and activates the first LED module.

The signal receiving module is connected in sequence with a second control switch and a second LED module; after the signal receiving module receives the digital electro signals, the signal receiving module transmits a control signal to the second control switch; after the second control switch has received the control signal from the signal receiving module, the second control switch activates the second LED module.

The optical fibers are enclosed by a spiraling elastic metal sheath; electrical wires that connect the signal input module and the signal receiving module, and fillers that limit movements of the optical fibers and the electrical wires with respect to the spiraling elastic metal sheath are also provided inside the spiraling elastic metal sheath.

The fillers are Kevlar® fibers from DuPont™; the Kevlar® fibers are arranged along a lengthwise direction of the spiraling elastic metal sheath.

Compared with the prior art, the present invention has the following beneficial effects:

The present invention has a simple structure and a low production cost.

The armored cable used by the present invention can fix the optical fibers and the electrical wires and protect them from being torn, scratched or crushed, thereby enhancing the reliability of the product.

After connection, the connecting device according to the present invention enables direct indication on a surface of the connecting device whether the power source signal and the digital signals are successfully transmitted, thereby facilitating checking and maintenance, and enhancing the installation efficiency of the product. The present invention provides steady transmission of data via optical fibers free from power lost or interruption.

### BRIEF DESCRIPTION OF THE DRAWINGS

FIG. 1 is a concept diagram of a circuit according to the present invention.

FIG. 2 is a circuit diagram of the signal input module of the present invention.

FIG. 3 is a circuit diagram of an E/O (electro/optical) conversion module of the present invention.

FIG. 4 is a circuit diagram of an O/E (optical electro) conversion module of the present invention.

FIG. 5 is a circuit diagram of a signal receiving module of the present invention.

FIG. 6 is a circuit diagram showing the first control switch and the first LED module.

FIG. 7 is a circuit diagram showing the second control switch and the second LED module.

FIG. 8 is a circuit diagram of the power source module of the present invention.

FIG. 9 is a structural view of an armored cable according to an embodiment of the present invention.

FIG. 10 is a sectional view along A-A of FIG. 9.

FIG. 11 is a structural view of an armored cable according to another embodiment of the present invention.

### DETAILED DESCRIPTION OF THE INVENTION

The technical solutions provided by the present invention will be clearly and thoroughly described below with reference to the accompanying drawings of the embodiments. Obviously, the embodiments as described below are not all but only part of the possible embodiments of the present invention. Other embodiments conceivable by a person skilled in this field of art in accordance with the teachings of the present invention and without any inventive effort should also fall within the scope of protection of the present invention.

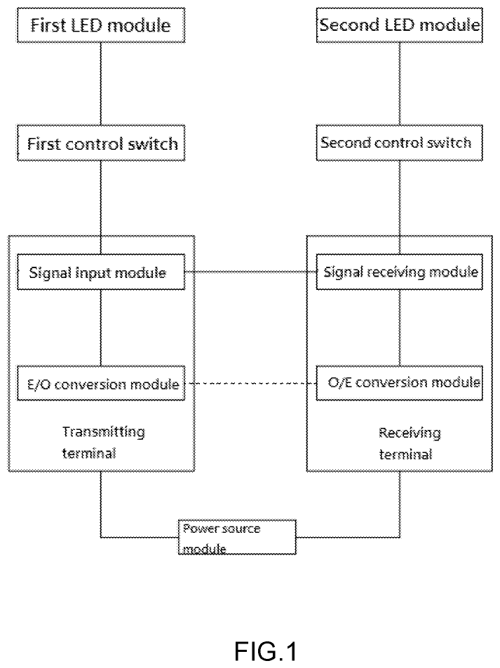

As shown in FIG. 1, an active optical fiber HDMI connecting device is provided, comprising a transmitting terminal, a receiving terminal, optical fibers, and a power source module; the power source module provides power to the transmitting terminal and the receiving terminal; the transmitting terminal comprises a signal input module and an E/O conversion module; the receiving module comprises an O/E conversion module and a signal receiving module; the signal input module inputs digital electro signals to the E/O conversion module; the E/O conversion module converts the digital electro signals to optical signals; the optical fibers transfer the optical signals to the O/E conversion module; the O/E conversion module converts the optical signals to digital electro signals; the signal receiving module receives the digital electro signals converted by the O/E conversion module.

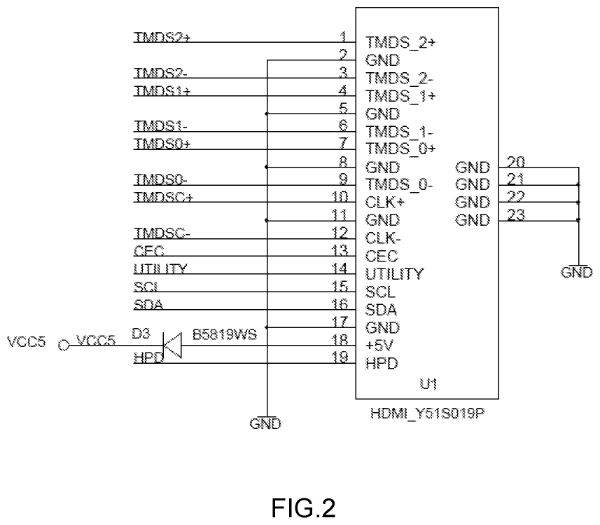

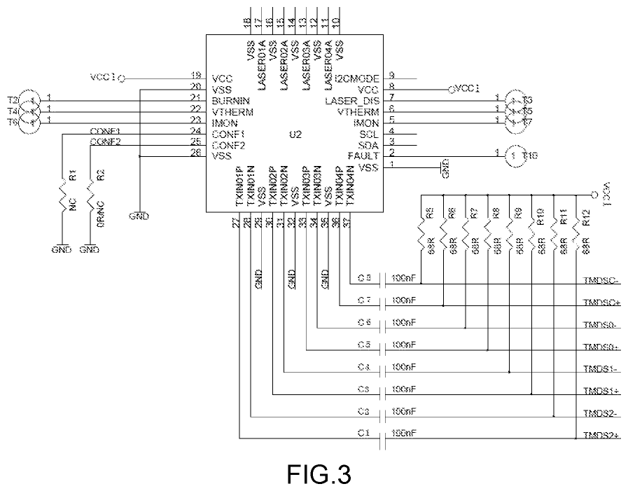

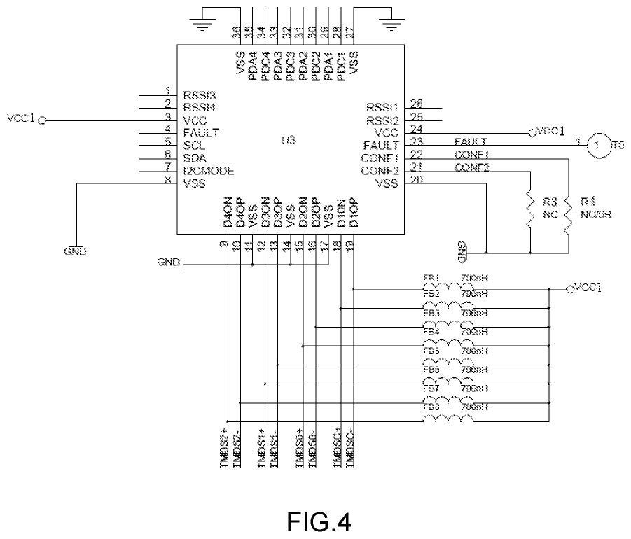

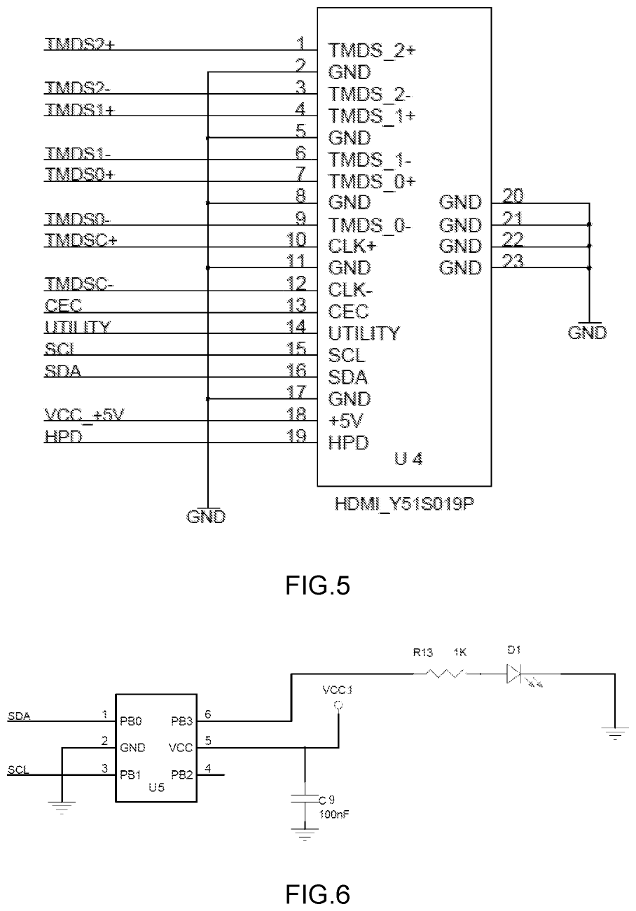

As shown in FIG. 2, the signal input module is a chip U1 of model number Y51S019P; pins 2, 5, 8, 11, 17 of the chip U1 are grounded; pins 1, 3, 4, 6, 7, 9, 10, 12 of the chip U1 are connected to the E/O conversion module. Preferably, as shown in FIG. 3, the E/O conversion module is a VCSEL driver chip U2; pins 27, 28, 30, 31, 33, 34, 36, 37 of the VCSEL driver chip U2 are connected to the pins 1, 3, 4, 6, 7, 9, 10, 12 of the chip U1 via capacitors C1, C2, C3, C4, C5, C6, C7, C8 respectively; pins 8, 19 of the VCSEL driver chip U2 are connected to the power source module; pins 1, 20, 26, 29, 32, 35 of the VCSEL driver chip are grounded; pins 24, 25 of the VCSEL driver chip are grounded via resistors R1, R2 respectively. In the present embodiment, the chip U1 can transfer the digital electro signals to the VCSEL driver chip U2 via the pins 1, 3, 4, 6, 7, 9, 10, 12 of the chip U1; the digital electro signals transferred to the VCSEL driver chip U2 are converted in the VCSEL driver chip U2 to optical signals which are then transferred to the O/E conversion module via the optical fibers. Preferably, as shown in FIG. 4, the O/E conversion module is a PIN_PD driver chip U3, wherein pins 3, 24 of the PIN_PD driver chip U3 are connected to the power source module, pins 8, 10 are grounded, pins 21, 22 are grounded via resistors R3, R4, and pins 9, 10, 12, 13, 15, 16, 18, 19 are connected to the signal receiving module. Preferably, as shown in FIG. 5, the signal receiving module is a chip U4 of model number Y51S019P; pins 2, 5, 8, 11, 17 of the chip U4 are grounded; pins 1, 3, 4, 6, 7, 9, 10, 12 of the chip U4 are connected to the pins 9, 10, 12, 13, 15, 16, 18, 19 of the PIN_PD driver chip U3; the PIN_PD driver chip U3 transfers the converted digital electro signals to the chip U4.

As shown in FIG. 3, in order to provide bias voltage and impedance matching for signal transmission between the chip U1 and the VCSEL driver chip U2, branched paths between each of the capacitors C1, C2, C3, C4, C5, C6, C7, C8 and the chip U1 are connected to the power source module via resistors R12, R11, R10, R9, R8, R7, R6, R5 respectively.

As shown in FIG. 4, in order that the signals between the chip U4 and the PIN_PD driver chip U3 match with resonance frequency, branched paths between the pins 9, 10, 12, 13, 15, 16, 18, 19 of the PIN_PD driver chip U3 and the chip U4 are connected to the power source module via inductors FB1, FB2, FB3, FB4, FB5, FB6, FB7, FB8 respectively.

When the connecting device according to the present invention is connected to a player or a display, the connecting device starts to operate only when the receiving terminal receives a power source signal from the transmitting terminal. In order to show whether the power source signal is transmitted successfully in the connecting device, the signal input module and the signal receiving module are electrically connected according to the present embodiment as shown in FIG. 1. The signal input module is also connected in sequence with a first control switch and a first LED module. Specifically, as shown in FIG. 2 and FIG. 5, pins 15, 16, 18, 19 of chip U1 are correspondingly connected to pins 15, 16, 18, 19 of chip U4. The pins 15, 16 of chip U1 are also connected to the first control switch. Specifically, as shown in FIG. 6, the first control switch is a chip U5 of type 1001. Pin 2 of chip U5 is grounded. Pin 5 of chip U5 is connected to the power source module. Pins 1 and 3 of chip U5 are correspondingly connected to pins 16, 15 of chip U1. Pin 6 of chip U5 is connected to the first LED module. The first LED module is LED D1. An anode of the LED D1 is connected to the pin 6 of chip U5 via a resistor R13. A cathode of the LED D1 is grounded. When determining whether transmission of the power source signal is normal, chip U1 inputs a power source signal to chip U4 via pin 18 of U1; after chip U4 has received the power source signal, chip U4 gives a feedback of a high level to chip U1 via pin 19 and a feedback of HDMI related signals to chip U1 via pins 15, 16; also, signals from the pins 15, 16 of chip U4 are transmitted to chip U5, and after chip U5 has received the signals from the pins 15, 16 of chip U4, chip U5 controls the LED D1 to illuminate, indicating normal transmission of the power signal. If chip U4 has not received any power source signal, no feedback signal will be given to chip U1, and also, there are no signals that trigger chip U5 to illuminate the LED D1, indicating that transmission of power signal is abnormal.

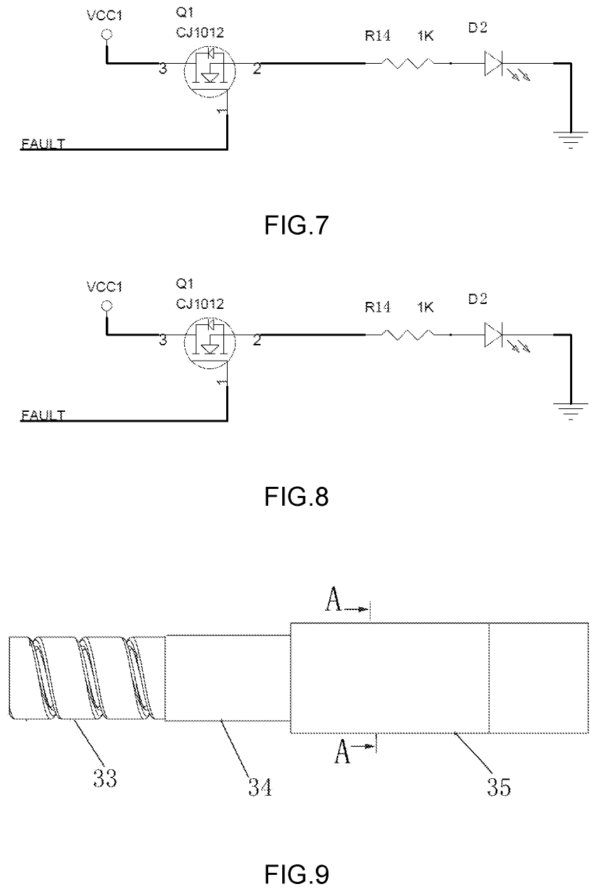

Upon successful connection of the power source signal, it is required to further determine whether transmission of digital electro signals between the transmitting terminal and the receiving terminal is normal. To fulfil this purpose, the signal receiving module according to the present embodiment is connected in sequence with a second control switch and a second LED module, as shown in FIG. 1. Specifically, as shown in FIG. 4 and FIG. 7, the second control switch is a MOS tube Q1. The second LED module is LED D2. A drain of the MOS tube is connected to the power source module; a source of the MOS tube is connected to an anode of LED D2 via resistor R14; a cathode of the LED D2 is grounded; a gate of the MOS tube is connected to pin 23 of the PIN_PD driver chip U3. To determine whether transmission of digital electro signals between the transmitting terminal and the receiving terminal is normal, the PIN_PD driver chip U3 receives digital signals, whereupon determination will be carried out, wherein if four channels in the PIN_PD driver chip U3 receives the digital signals, the PIN_PD driver chip will transmit a signal to the MOS tube via respective pins to activate the MOS tube so that LED D2 is powered up and illuminates, thereby indicating normal transmission of digital signals between the transmitting terminal and the receiving terminal; if at least one of the four channels in the PIN_PD driver chip U3 has no signals received, the PIN_PD driver chip U3 will not transmit any signal to control activation of the MOS tube, and hence the LED D2 will not illuminate, thereby indicating that transmission of digital signals between the transmitting terminal and the receiving terminal is abnormal.

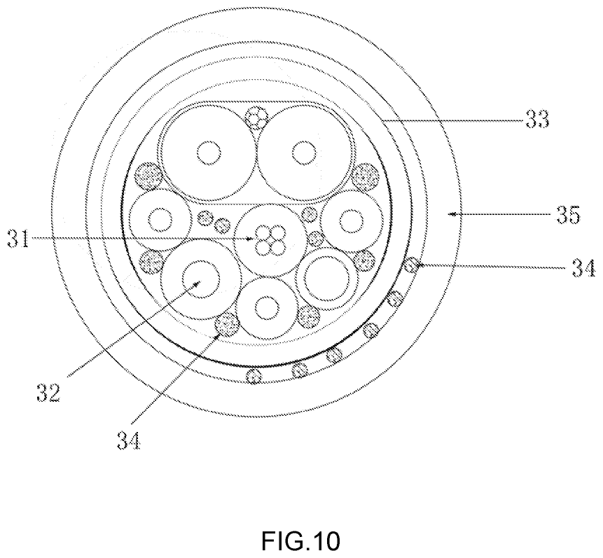

As shown in FIG. 9 and FIG. 10, the optical fibers 31 of the active optical fiber HDMI connecting device are enclosed by a spiraling elastic metal sheath 33; electrical wires 32 that connect the signal input module and the signal receiving module, and fillers 34 that limit movements of the optical fibers 31 and the electrical wires 32 with respect to the spiraling elastic metal sheath 33 are also provided inside the spiraling elastic metal sheath 33; a rubber cover 35 is provided enclosing the optical fibers 31 and the electrical wires 32, wherein the rubber cover 35 also encloses the spiraling elastic metal sheath 33; the fillers 34 are also provided between the spiraling metal sheath 33 and the rubber cover 35; the fillers 34 between the spiraling metal sheath 33 and the rubber cover 35 serve to limit movements of the spiraling metal sheath 33 and the rubber cover 35 with respect to each other.

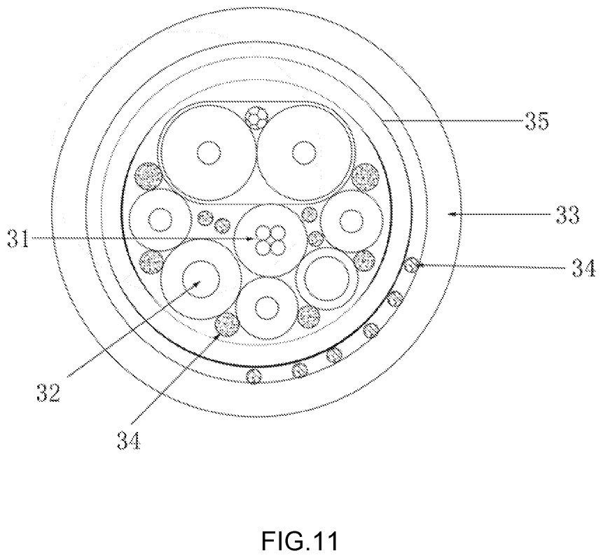

As shown in FIG. 11, the spiraling metal sheath 33 and the rubber cover 35 may switch in position, and the objects of the present invention can still be attained.

The fillers are Kevlar® fibers from DuPont™. The Kevlar® fibers are arranged along a lengthwise direction of the spiraling elastic metal sheath 33. Since Kevlar® fibers are made of composite materials which possess unique high resistance against tension and low density. When applied to the present invention, the Kevlar® fibers can increase the anti-tensional strength of the cables and wires so as to protect the electronic wires 32 and the optical fibers 31 from being torn. The rubber cover 35 is made of thermoplastic urethane (TPU) which is an elastic plastic material. TPU can be made into a wide range of degree of hardness, and it has high mechanical strength and a very preferable property for processing, also it is very resistant to low temperature, and it is also anti-grease, anti-mould and waterproof. The spiraling elastic metal sheath 33 is a stainless steel armored protective metal sheath, mainly for fixing and protecting the optical fibers and the electrical wires 32 such that they will not be torn, scratched or crushed, thereby enhancing the reliability of the product.

Although some preferred embodiments of the present invention have been shown and described, it should be understood that, various changes, modifications, replacements and variations of the disclosed embodiments can be carried out by a person skilled in this field of art in so far as there is no deviation from the principle and essence of the present invention. The scope of the present invention is defined by the claims or equivalent.

1. An active optical fiber HDMI connecting device, comprising:
a transmitting terminal, a receiving terminal, optical fibers, and a power source module;
the power source module provides power to the transmitting terminal and the receiving terminal;
the transmitting terminal comprises a signal input module and an electro/optical (E/O) conversion module;
the receiving module comprises an optical/electro (O/E) conversion module and a signal receiving module;
the signal input module inputs digital electro signals to the E/O conversion module;
the E/O conversion module converts the digital electro signals to optical signals;
the optical fibers transmit the optical signals to the O/E conversion module;
the O/E conversion module converts the optical signals to digital electro signals;
the signal receiving module receives the digital electro signals converted by the O/E conversion module,
bias voltage and an impedance matching module are between a first single chip and the VCSEL driver chip, and
branched paths between each of the plurality of capacitors and the first single chip are connected to the power source module via respective each of the plurality of resistors.

2. The active optical fiber HDMI connecting device of claim 1, wherein
the signal input module is the first single chip,
the E/O conversion module is a VCSEL driver chip,
the signal receiving module is a second single chip,
the O/E conversion module is a PIN_PD driver chip,
the first single chip, the VCSEL driver chip and the PIN_PD driver chip are electrically connected, and
the second single chip is electrically connected to the PIN_PD driver chip.

3. (canceled)

4. The active optical fiber HDMI connecting device of claim 2, wherein a resonance frequency matching module is connected between the second single chip and the PIN_PD driver chip.

5. The active optical fiber HDMI connecting device of claim 1, wherein
the signal input module and the signal receiving module are electrically connected with each other,
the signal input module is connected in sequence with a first control switch and a first LED module,
the signal input module inputs a power source signal to the signal receiving module
the signal receiving module transmits a high level signal to the signal input module based on reception of power source signal to the signal receiving module,
the signal input module transmits a control signal to the first control switch based on the reception of the high level signal to the signal input module,
the first control switch receives the control signal and activates the first LED module.

6. The active optical fiber HDMI connecting device of claim 1, wherein
the signal receiving module is connected in sequence with a second control switch and a second LED module
the signal receiving module transmits a control signal to the second control switch based on a reception of the digital electro signals to the signal receiving module,
the second control switch activates the second LED module based on a reception of the control signal from the receiving module to the control switch.

7. The active optical fiber HDMI connecting device of claim 1, wherein
the optical fibers are enclosed by a spiraling elastic metal sheath,
electrical wires that connect the signal input module and the signal receiving module, and fillers that limit movements of the optical fibers and the electrical wires with respect to the spiraling elastic metal sheath are also provided inside the spiraling elastic metal sheath.

8. The active optical fiber HDMI connecting device of claim 7, wherein the fibers are arranged along a lengthwise direction of the spiraling elastic metal sheath.
